(19) United States
(12) Patent Application Publication
(10) Pub. No.: US 2009/0003284 A1
(43) Pub. Date: Jan. 1, 2009

(54) Call Admission Control in an Ad Hoc Network

(76) Inventors: Choong M. Chin, Kuala Lumpur (MY); Moh L. Sim, Selangor (MY)

Correspondence Address: NIXON & VANDERHYE, PC, 901 NORTH GLEBE ROAD, 11TH FLOOR, ARLINGTON, VA, 22203, US

(21) Appl. No.: 12/097,107

(22) PCT Filed: Nov. 27, 2006
(86) PCT No.: PCT/GB2006/004424

§ 371 Date: Jun. 12, 2008

(30) Foreign Application Priority Data
Dec. 15, 2005 (MY) PI20055918
Apr. 27, 2006 (EP) 06252269.3

(51) Int. Cl. H04Q 7/36

(52) U.S. Cl. 370/332

(57) ABSTRACT

A wireless node (n5) can control its admission as an incoming node to a network in which communication takes place between nodes (n1, n2, n3 etc) over wireless links (m). The incoming node (n5) monitors transmissions of transmitter nodes in the network to provide location data corresponding to their respective locations. The node (n5) has a controller (7) that develops simulated location data corresponding to the locations of receiver nodes in the network using the location data for the transmitter nodes. The controller constructs a link gain matrix using the location data for the transmitter nodes and the simulated location data for the receiver nodes, and processes the matrix to compute the maximum achievable value of the signal to interference relationship (SIR) for the network when the incoming is assumed to have joined the network, and the incoming node is admitted to the network if the maximum value exceeds a threshold. The accuracy of the simulated receiver location data is tested by analysis of the link gain matrix without including the incoming node.

### FIELD OF THE INVENTION

This invention relates to call admission control for an ad hoc network.

### BACKGROUND

Ad hoc wireless networks are well known in which nodes join and leave the network over time. The nodes may for example form a Bluetooth or WiFi network although many other applicable network architectures and signal transmission protocols are known in the art. The nodes may comprise personal mobile telecommunications devices, personal digital assistants, remote sensors and many other devices. A general review of ad hoc networks is provided by T. S. Rappaport, in “Wireless Communications, Principles and Practice”, Parson Education International, 2^{nd} edition, 2002.

Ad hoc networks need not have any permanently fixed infrastructure and so network functions have to be coordinated in a distributed manner between the network nodes. Calls can be forwarded through an ad hoc network by a process known as multi-hop, over successive wireless links between adjacent nodes. Each node acts as a router and forwards call data to an adjacent node, towards its final destination. This is in contrast to conventional cellular wireless networks in which each mobile device communicates directly with a base station, which controls all transmission and routing functions.

A feature of ad hoc networks is the relationship between their power control, call admission control, network topology and routing algorithms. Each node has a finite transmission power capability and so if several calls are routed through the node, the power needs to be shared between them. If too many calls are handled by a particular node, the power available may be insufficient to provide an acceptable signal-to-interference plus noise ratio (SINR) over links between adjacent nodes. The power control and routing algorithms are configured to try to maintain an acceptable SINR for all links between the nodes of the ad hoc network.

The call admission control mechanism determines whether a new node can be admitted into the network, for example to admit a new call from a mobile device that wants to join the network. It is desirable to admit as many users as possible, whilst minimizing any reduction in SINR for existing calls due to additional co-channel interference caused by the admission of a new user. The admission decision is based on several factors including the available radio resources, available time and frequency channels, transmit power, accessibility to access points and also acceptable link quality between the nodes of the network, in terms of SINR.

In early works on power control, balancing the SINRs of all radio links was proposed using a centralized control system. Reference is directed to J. M. Aein, “Power balancing in systems reemploying frequency reuse”, COMSAT Tech. Rev., pp. 277-299, 1973. However, later works on power control proposed SINR-balancing algorithms that are distributed amongst the network nodes—see G. J. Foschini and Z. Miljanic, “A Simple Distributed Autonomous Power Control Algorithm and its Convergence”, IEEE Transactions on Vehicular Technology, Vol. 42, No. 4, November 1993. Also, reference is directed to J. Zander, “Distributed Co-channel Interference Control in Cellular Radio Systems”, IEEE Transactions on Vehicular Technology, Vol. 41, No. 3, pp. 305-311, August 1992.

For this so-called admission-centric approach, the algorithms, which use either a synchronous or an asynchronous iterative approach, converge geometrically to a finite power level so that all the user links in the network will meet the required SINR threshold, provided that the network system is feasible such that all its power constraints can be satisfied. However if no feasible power assignment is possible for a given SINR threshold, the iterations of the algorithms diverge, due to the non-feasibility of the network. Hence there is a need for an efficient mechanism to decide at an early stage whether a set of links can be served by nodes of the network at the same time, and whether a new link will be able to be admitted into an already feasible system. Although the distributed power control scheme is more practical than a centralized one, in a dynamic network environment such an approach may require the removal of some existing calls in order to balance the overall quality of service (QoS) requirements for the rest of the existing calls. Reference is directed to M. Andersin, Z. Rosberg and J. Zander, “Gradual removals in cellular radio networks”, Wireless Networks, vol. 2, no. 1, pp. 27-43, (1996).

In a series of papers by Bambos et al. (1995, 2000), the concept of active link protection is introduced in order to minimize the degradation of SINR of currently active links whilst new links are accessing the network. See for example N. Bambos, S. C. Chen and G. J. Pottie, “Radio link admission algorithms for wireless networks with power control and active link quality protection”, in Proc. IEEE INFOCOM'95, Boston, Mass., (1995), and also N. Bambos, S. C. Chen and G. J. Pottie, “Channel access algorithms with active link protection for wireless communications networks with power control”, IEEE/ACM Transactions on Networking 8(5), pp. 583-597, (2000).

For this approach, a node that seeks to form a new link to the network, first starts to transmit at low power. The transmit power for the new link is then gradually increased by a factor of δ>1 until it is successfully admitted to the system. In response to the increased interference caused by the new link, the currently active links update their powers according to standard distributed power control algorithms, but instead of satisfying the required SINR threshold they aim for an enhanced SINR threshold target which is also a multiple of δ>1. By doing so, the existing links remain active throughout the power updating process while the system negotiates whether to admit the new link or not. When new links are not able to be accommodated they then simply exit from the network without causing any drop of QoS for the existing active links. The algorithms presented by Bambos et al. (2000) do not assume there is any interlink communication, centralized system of computation or even admission of links one at a time. Although such an approach eliminates many assumptions based on admission-centric power control, the problem of adjusting δ adaptively when the network is either congested or not, remains unresolved. Furthermore, for new links that are being rejected by the system, the amount of time spent waiting before exiting from the system constitutes a waste of power resources and therefore generates undue interference for other active links.

A different approach has been proposed by M. Xiao, N. B. Shroff and E. K. P. Chong in “Distributed admission control for power-controlled cellular wireless systems”, IEEE/ACM Transactions on Networking, vol. 9, no. 6, pp. 790-800, December 2001. A call admission control (CAC) is proposed, based on a system parameter called a discriminant, which characterises the feasibility of admitting a new link, based on a matrix of inequality constraints for an existing, feasible network system. The node to be admitted initially operates at a constant power level for the new link whilst the method tests its admissibility to the network. One disadvantage of this approach is that it is necessary to wait until the network system settles down to make an admission decision, or it has to satisfy an upper bound interference criterion during the iterative process before being admitted. Thus, a waiting period occurs in either case, and unnecessary disturbances are made to the power levels for existing network links should the new link be eventually rejected by the network.

An admission-centric power control has been proposed in which each incoming call (considering only the uplink) first monitors pilot tones from all the active base stations in order to measure the base-to-mobile power gains, which captures the power loss of a path from the base stations to the mobile stations. See M. Andersin, Z. Rosberg and J. Zander, “Gradual removals in cellular radio networks”, Wireless Networks, vol. 2, no. 1, pp. 27-43, (1996). For each existing mobile-to-base uplink in the channel, the algorithm assumes the receiver's thermal noise level, and the transmitter's power level is communicated to all other uplinks. On receipt of this information, all uplinks can then compute the required power levels to satisfy the SINR threshold or until the maximum power constraint of an uplink is violated, in which case the new call is rejected. Here the method assumes that only one new call is trying to be admitted at a time and that global information for an existing, feasible system can be obtained. Studies by Grandhi et al. (1993) show that when the information for the global link gain matrix is available i.e. the gains for all the links is known, and by neglecting the white noise factor, the maximum achievable signal-to-interference (SIR) can be determined, and provided it is greater than the threshold requirement, then there exists a feasible solution for all power constraints. Reference is directed to S. A. Grandhi, R. Vijayan, D. J. Goodman and J. Zander, “Centralized power control in cellular radio systems”, IEEE Transactions on Vehicular Technology, 42(4), pp. 466-468, (1993)—hereinafter referred to as “Grandhi (1993).

The present invention seeks to provide call admission control for a network, wherein a prediction of the maximum achievable SIR can be made when the aforesaid global link gain information is not available.

### SUMMARY OF THE INVENTION

Broadly stated, the invention provides a method of controlling admission of a incoming node to a network in which communication takes place between nodes of the network over wireless links, comprising:

monitoring transmissions of transmitter nodes in the network to provide location data corresponding to their respective locations;

providing simulated location data corresponding to the locations of receiver nodes in the network that receive the transmissions over the links from respective ones of the transmitter nodes, based on the location data for the transmitter nodes;

computing a parameter corresponding to the maximum achievable value of a signal to interference relationship for transmissions over the links in the network when including the incoming node, as a function of the location data for the transmitter nodes and the simulated data for the receiver nodes; and

admitting the incoming node in dependence upon the value of said parameter.

The method can be performed at the incoming node, which does not need to have global information concerning all the link gains in the network

The accuracy of the simulated location data for the receiver nodes can be tested before computing said parameter corresponding to the maximum achievable value of the signal to interference relationship. This can be done by computing a test maximum achievable value of the signal to interference relationship for transmissions over the links in the network without the incoming node, as a function of the location data for the transmitter nodes and the simulated location data for the receiver nodes, and determining if the computed test maximum achievable value of the relationship is of a value that corresponds to a feasible network.

The location data corresponding to the locations of receiver nodes can be re-simulated in the event that said test maximum achievable value of the signal to interference relationship does not correspond to a feasible network

The simulated location data for the receiver nodes may be provided by postulating the location of a receiver node corresponding to each of the monitored transmitter nodes, at an essentially random location within a predetermined area surrounding the respective transmitter node. The predetermined area may correspond to a circular area centred on the respective transmitter node.

The incoming node may be admitted to the network if the computed maximum achievable value of the signal to interference relationship for transmissions over the links in the network when including the incoming node, adopts a predetermined relationship to a predetermined admittance value.

This maximum achievable value of the signal to interference relationship may be computed a plurality of times to provide a plurality of computed values thereof, so that an average of said computed values can be formed and compared with the admittance value.

The invention also includes a wireless node configured to perform the aforesaid method and a computer program to perform the method.

### BRIEF DESCRIPTION OF THE DRAWINGS

Features and advantages of the invention will become apparent from the following description of an embodiment thereof, given by way of illustrative example, and the accompanying drawings in which:

FIG. 1 is schematic illustration of an ad hoc wireless network;

FIG. 2 is a schematic block diagram of transmit/receive circuitry of a node of the network shown in FIG. 1;

FIG. 3 is a schematic diagram of the processes run by the controller shown in FIG. 2; and

FIG. 4 is a block diagram of an admission control process in accordance with the invention.

### DETAILED DESCRIPTION

### 1. Network Overview

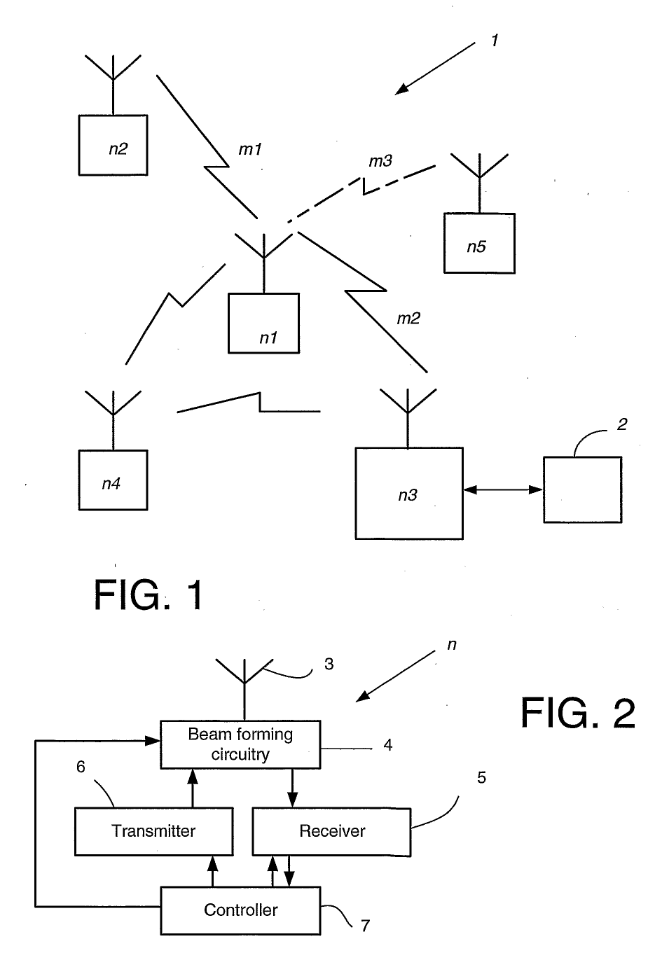

Referring to FIG. 1, a wireless network 1 comprises a plurality of transmit/receive wireless nodes n1, n2, n3, n4, n5 etc that can communicate with one another when within a transmission range determined in part by the power level P at which the transmitting node operates. In FIG. 1, a transmission path for signal communication may be established between node n2 and node n3 as a multi-hop through the intermediary of node n1. The transmission paths between adjacent nodes constitute links, for which one of the nodes act as a sender node s and the other operates as a receiver node r. Generally, there are M−1 links in the network 1. The links may be bidirectional to provide an uplink and a downlink between adjacent nodes n. Thus, communication between nodes n2 and n3 occurs via node n1 through links m1 and m2 in FIG. 1.

The network 1 is an ad hoc network in which nodes n join and leave the network over time. The nodes n may for example form a Bluetooth or WiFi network although many other applicable network architectures and signal transmission protocols will be known to those, skilled in the art. The nodes may comprise personal mobile telecommunications devices, personal digital assistants, remote sensors and many other devices. In the example of FIG. 1, node n3 acts as an access point to the network, so as to allow signals to be routed into and from the network, for example through a conventional land telecommunications network 2.

FIG. 2 is a schematic illustration of the network communication circuit features of one of the nodes n, and it will be understood the other nodes include corresponding circuitry and admission control software. The node n includes an antenna 3 with associated beam forming circuitry 4 that controls the orientation of the directive pattern of the antenna 3. A receiver 5 is configured to receive data signals from a downlink m and a transmitter 6 feeds data signals to the antenna 3 for transmission on an uplink M. The node can handle multiple data signal streams in different channels, which may be frequency and/or time delineated. The operation of the beam forming circuitry 4 and the transmitter is controlled by a controller 7.

The controller 7 includes a processor and associated memory that is operable to run a control and connection—CAC algorithm, as described in more detail hereinafter. The controller 7 also runs a power control algorithm for controlling the transmission power P of the node and the distribution of power between the various channels of the links m handled by the node, to achieve a satisfactory SINR for the individual links. Details of power control algorithms that are distributed, autonomous and operate using local interference measurements can be found in G. J. Foshini and Z. Miljanic, “A simple distributed autonomous power control algorithm and its convergence”, IEEE Transactions on Vehicular Technology, vol 42, pp. 641-646, 1993. Thus, the nodes of the network each use such an algorithm to adjust their transmission power. However, a saturation point can be reached for the network, at which increasing the power P of a node n does not improve its SINR and the associated quality of service (QoS). In this situation, the network 1 becomes infeasible.

For node n1, the circuitry of FIG. 2 acts as a transponder to receive signals from node n2 and transmit them to node n3, which is outside the transmission range of n2. Signals are received from node 122 by antenna 3 and passed to a receiver 5. The received signals are passed to a transmitter 6 so as to be transmitted through antenna 3 to the node n3.

For node n2, the circuitry of FIG. 2 acts as a duplex head end for link m1.

Node n5 in this example constitutes an incoming node that will attempt to join the network 1, by opening a link m3 to node n1. This will create a total of M links. The feasibility of opening the link m3 is judged by the CAC algorithm run by the controller 7 of node n5, as will be explained in more detail hereinafter.

When the network is in operation, the signals processed by each node n from the respective links are degraded by the signals on other links, which act as noise. Considering for example operation of node n1, it receives signals from n2 and transmits them to node n3. The node n1 will also receive unwanted signals from other network nodes that are within range, such as nodes n4 and n5 shown in FIG. 1. These unwanted signals produce interference with the signal received from the node n2 at the node n1, which can be measured in terms of the aforementioned SIR, or SINR if the degradation by external or internal noise such a white noise is taken into account.

### 2. Basic Network Model

In an ad hoc network, nodes such as n join and leave the network 1 over time.

The following discussion considers an ad hoc network system with M−1 active pairs of concurrent communications, the so-called active links, where M>1. Each communication link consists of a receiver node and a sender node and without loss of generality there exists a subset of sender nodes S={s₁,s₂, . . . , s_{M-1}} transmitting packets of data to another subset of receiving nodes R={r₁, r₂, . . . , r_{M-1}}. The following analysis, relates to a downlink, where a sender node sᵢ transmits to the receiver node rᵢ. The objective of power control in such a dynamic environment is to ensure that all communication pairs achieve a SINR above a required threshold.

A situation will now be considered where a new incoming link denoted by M wants join the network 1 of M−1 links. For example, the node n5 may want to be admitted to the network 1 and open link m3 with node n1. In this situation, node n5 wishes to determine the maximum achievable SIR that it would jointly achieve should it be admitted to the network.

We denote Gᵣ_{ᵢ}ₛ_{ᵢ} as the gain of the communication link between the rᵢth receiver node and the sᵢth sender node

$${G}_{{r}_{i} {s}_{i}} = \frac{{S}_{{r}_{i} {s}_{i}}}{{[ {( {x}_{{r}_{i}} - {x}_{{s}_{i}} )}^{2} + {( {y}_{{r}_{i}} - {y}_{{s}_{i}} )}^{2} + {( {z}_{{r}_{i}} - {z}_{{s}_{i}} )}^{2} ]}^{υ / 2}} \qquad ( 2.0 )$$

where Sᵣ_{ᵢ}ₛ_{ᵢ} is the attenuation factor, x, y, z denote the three-dimensional coordinate position in the network 1, and the subscripts rᵢ and sᵢ denote the receiver and sender nodes respectively. The parameter ν is a constant that models the propagation path loss for the link. We assume that Sᵣ_{ᵢ}ₛ_{ᵢ}, 1≦i≦M, are independent, log normal, identically distributed, random variables with 0 dB expectation and σ² log variance. The value of σ in the range of 4-10 dB and the propagation constant ν in the range of 3-5 usually provide good models for urban propagation—see W. C. Y. Lee, Mobile Cellular Telecommunication Systems, McGraw Hill Publications, New York, 1989.

In general, given that there are M pairs of interfering nodes in the enlarged system when the new node is admitted, we can denote the SINR of the rᵢth receiver node by

$${\overline{γ}}_{{r}_{i}} = \frac{{G}_{{r}_{i} {s}_{i}} {P}_{{s}_{i} }}{{\sum }_{k \neq i} {G}_{{r}_{i} {s}_{k}} {P}_{{s}_{k}} + {η}_{{r}_{i}}} , 1 \leq i , k \leq M \qquad ( 2.1 )$$

where Pₛ_{ᵢ} is the transmit power of sender node sᵢ and ηᵣ_{ᵢ}>0 is the white noise detected by node rᵢ. For each receiver node rᵢ we assume there will be a common SINR or SIR threshold requirement denoted by γ^{∞}>0, representing the receiver node rᵢ minimal quality of service (QoS) it must support in order to operate successfully. Following the above arguments we then have

γ̅ᵣ_{ᵢ}≦γ^{∞}, 1≦i≦M (2.2)

In matrix format, the relationships (2.1) and (2.2) can be expressed as

(I−F)P≦Θ,P>0

where

$$Θ = {[ \frac{{γ}^{∞} {η}_{{r}_{1}}}{{G}_{{r}_{1} {s}_{1}}} , \frac{{γ}^{∞} {η}_{{r}_{2}}}{{G}_{{r}_{2} {s}_{2}}} , … , \frac{{γ}^{∞} {η}_{{r}_{M}}}{{G}_{{r}_{M 1} {s}_{M}}} ]}^{T} ,$$

P=[Pₛ_{₁}, Pₛ_{₂}, . . . , Pₛ_{_{M}}]^{T} and F=(Fᵢⱼ) is a matrix having the entries Fᵢⱼ=0 for i=j and

$${F}_{ij} = \frac{{γ}^{∞} {G}_{{r}_{i} {s}_{j}}}{{G}_{{r}_{i} {s}_{i}}}$$

for i≢j, 1≦i, j≦M. It can be shown using Perron-Frobenius theorem that if the spectral radius of F lies within a unit circle of radius 1 then (I−F) is invertible and that there exists a unique solution

P*=(I−F)⁻¹Θ>0

However in order to obtain the unique solution P* global information for the link gain matrix needs to be acquired. In order to obtain this information, the gains of the individual links of the network would need to be ascertained, which in turn requires information concerning the locations of all the relevant transmitter and receiver nodes in the network. This information is not available to a node such as n5, when attempting to gain admission to the network 1.

### 3. Converged SIR Prediction

An alternative approach is used according to the invention to assess the matrix properties of F, and predict the maximum achievable SIR for all the active links so that the feasibility condition (2.2) can be tested upon arrival of a new link for an incoming node to the network. By ignoring the white noise factor from the definition of SINR in equation (2.1), the SIR γᵣ_{ᵢ} of node rᵢ, can be defined as

$${γ}_{{r}_{i}} = \frac{{G}_{{r}_{i} {s}_{i}} {P}_{{s}_{i}}}{{\sum }_{k \neq i} {G}_{{r}_{i} {s}_{k}} {P}_{{s}_{k}}} = \frac{{P}_{{s}_{i}}}{{\sum }_{k \neq i} \frac{{G}_{{r}_{i} {s}_{k}}}{{G}_{{r}_{i} {s}_{i}}} {P}_{{s}_{k}}} \qquad ( 3.1 )$$

for 1≦i≦M where Pₛ_{ᵢ}>0 is the sender node transmit power. Note also that by comparing (2.1) and (3.1) we have the following inequality

γ̅ᵣ_{ᵢ}≦γᵣ_{ᵢ}, 1≦i≦M

where the SIR value constitutes an upper bound criteria of SINR for all receiver nodes rᵢ.

In order to find the maximum achievable SIR common for all the links, an M×M irreducible, nonnegative matrix A=(Aᵢⱼ) is constructed such that Aᵢⱼ=0 for i=j and

$${A}_{ij} = \frac{{G}_{{r}_{i} {s}_{j}}}{{G}_{{r}_{i} {s}_{i}}}$$

for i≢j, 1≦i, j≦M.

Equation (3.1) can be written as an eigensystem

AP=ΛP

where

$$Λ = diag [ \frac{1}{{γ}_{{r}_{1}}} , \frac{1}{{γ}_{{r}_{2}}} , … , \frac{1}{{γ}_{{r}_{M}}} ] .$$

Grandhi et al. (1993) supra, considered a matrix A comprising a M×M irreducible nonnegative matrix with eigenvalues {λᵣ_{ᵢ}}ᵢ₌₁^{M}.

Grandhi shows that for an eigenvalue λ*=max{|λᵣ_{ᵢ}|}ᵢ₌₁^{M} with a corresponding eigenvector P* having strictly positive entries, there exists a unique SIR value γ_{M}*, which is a maximum achievable or actual SIR value for all the links, which can be expressed as γ_{M}*=1/λ* with P* being the transmitter power vector to achieve γ_{M}* in the system.

For a notional centralized power control (CPC) scheme using SIR measurements according to equation (3.1), the notional central controller can acquire knowledge of matrix A, that is, knowledge of the signal strengths in all the active links. Then, using Grandhi's approach, it would be possible to calculate the maximum achievable SIR value γ_{M}* in all the links in the system, and also the transmitter powers P* in order to attain γ_{M}* in the network system.

However, a newly arriving node pair that wishes to form a new link M with the network 1 does not have such global information concerning the positions of the nodes that make up the active links M−1 in the network. Thus, a newly arriving node cannot gain knowledge of the matrix A, because this requires a knowledge of the link gains G, which in turn requires knowledge of the locations of the nodes—see equations (2.0) and (2.1).

In accordance with the invention, an approximation of the true matrix A is developed by setting up a simulation of a CPC scheme. This simulation is referred to herein as a quasi-centralized power control (QCPC) scheme, and is configured to predict the actual maximum achievable SIR in the network by an algorithmic simulation. The QCPC simulation can be run by a node n seeking to be admitted to the network. If the predicted SIR value is greater than the threshold requirement, and provided the decision error made is small enough, the new link defined by the new node pair, will be admitted into the network. All the existing active links will then autonomously adjust their power levels according to some distributed power control algorithms in response to the new node.

### 4. Call Admission Control Mechanism

For a node such as node n5 seeking admission to the network, to establish a link corresponding to link M, e.g. link m3, we make the following assumptions:
(i) The number of active links M−1 can be determined by an incoming node for the new link M.
(ii) All the sender nodes know the positions of their surrounding co-channel sender nodes positions, that is, the 3-dimensional coordinates (xₛ_{ᵢ}, yₛ_{ᵢ}, zₛ_{ᵢ}) are known for all i. Note that (i) and (ii) can ascertained by using beam forming techniques or utilizing smart antennas as described in more detail later. However, the locations of the receiver nodes for the active links M−1 are not known by the incoming node.
(iii) The link gains between an incoming receiver node and other active sender nodes {Gᵣ_{_{M}}ₛ_{ⱼ}} for 1≦j≦M, can be measured. Practically this can be achieved by requiring all the sender nodes to send a constant power pilot tone, which is a common practice in typical cellular systems.
(iv) The radio coverage of each node has a known radius Rₒ.

Based on these assumptions, the new incoming receiver node for new link M can measure Gᵣ_{_{M}}ₛ_{ⱼ}, j≢M.

The active receiver nodes' exact locations are unknown to the new sender node (only the cumulative interference can be measured) but in accordance with the invention, the locations of the receiver nodes can be simulated by assuming each receiver node is placed isotropically i.e. essentially randomly, at a location within a sphere around its respective sender node having a common radius Rₒ for all such nodes. The former (x,y,z) position used in equation (2.0) is thus can be approximated by means of a uniform spatial distribution within a sphere of radius Rₒ. Based on such information, the node seeking admission to establish a new link M, can construct an M×M matrix A=(Aᵢⱼ) such that Aᵢⱼ=Gᵣ_{ᵢ}ₛ_{ⱼ}/Gᵣ_{ᵢ}ₛ_{ᵢ}>0 for i≢j and Aᵢⱼ=0 for i=j. Using the approach of Grandhi et al. (1993) supra, and by carrying out simulations of the positions of the active receiver nodes with respect to their sender nodes, the incoming node n for the new link M can decide whether or not to admit itself to the existing network.

To this end, a QCPC simulation link gain matrix A is defined as:

$${A}_{ij} ( k ) = \{ \begin{matrix}{\hat{G}}_{{r}_{i} {s}_{j}} ( k ) / {\hat{G}}_{{r}_{i} {s}_{i}} ( k ) & i \neq j , i \neq M \\ {G}_{{r}_{M} {s}_{j}} / {G}_{{r}_{M} {s}_{M}} & i = M \\ 0 & i = j\end{matrix}$$

where k is sampling integer, where k≦N, and

$${\begin{matrix}{\hat{G}}_{{r}_{i} {s}_{i}} ( k ) = \frac{{\hat{S}}_{{r}_{i} {s}_{i}}}{{[ {( {\hat{x}}_{{r}_{i}} ( k ) - {x}_{{s}_{i}} )}^{2} + {( {\hat{y}}_{{r}_{i}} ( k ) - {y}_{{s}_{i}} )}^{2} + {( {\hat{z}}_{{r}_{i}} ( k ) - {z}_{{s}_{i}} )}^{2} ]}^{υ / 2}} & ( 4.1 )\end{matrix}}_{\frac{□}{□} {r}_{i}} \qquad ( 4.1 )$$

such that the co-ordinates (\hat{x}ᵣ_{ᵢ}(k), ŷᵣ_{ᵢ}(k), \hat{z}ᵣ_{ᵢ}(k)) are randomly positioned within a sphere of radius Rₒ. For i≢j, i≢M we let ln Ŝᵢⱼ˜N(0, \hat{σ}²) where \hat{σ}˜U(4, 10).

The QCPC simulation link gain matrix can be used to predict the SIR and improve the decision making in call admission control. Without the prediction, a call would be first admitted and either it would continue to be served or denied at a later time after a waiting period. With the help of the SIR prediction, an admission decision can be made by the new node immediately upon arrival at the location of the network.

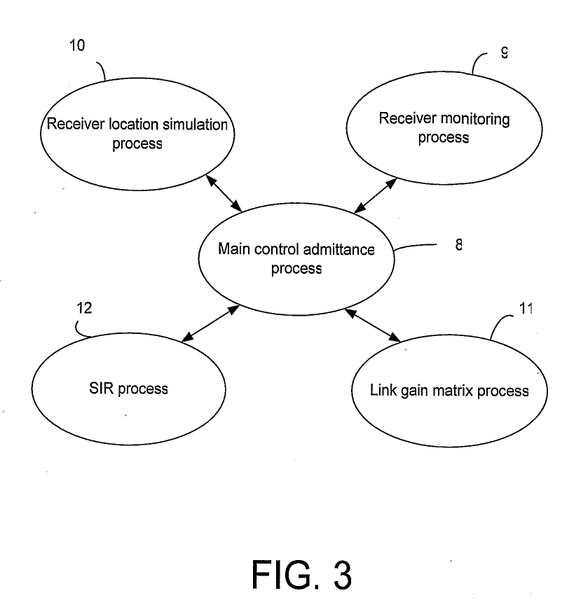

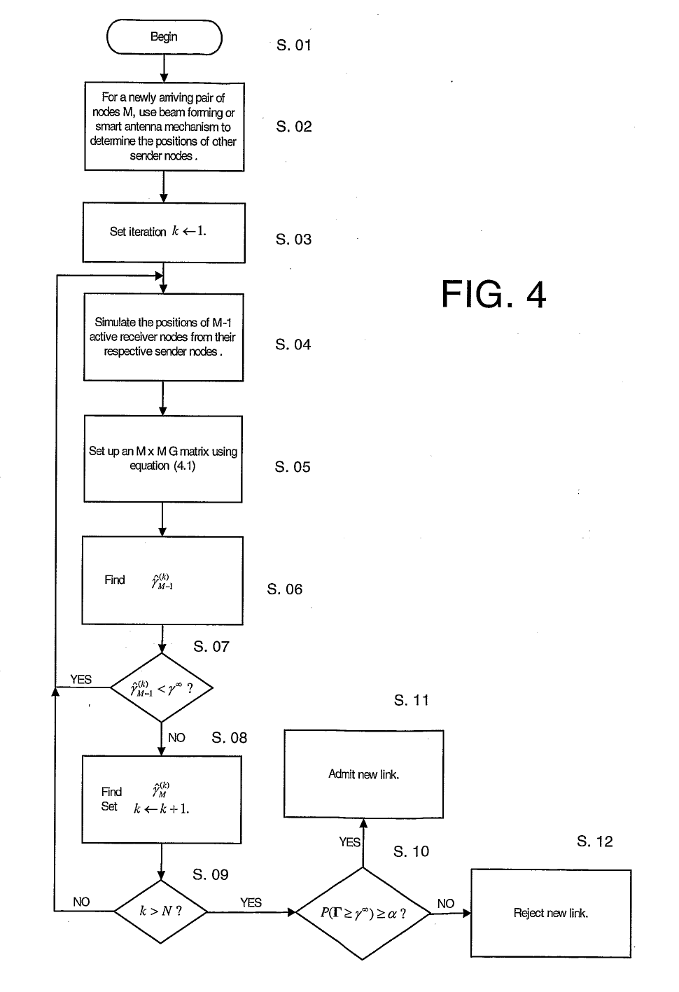

This will now be explained in more detail with reference to FIGS. 3 and 4 which respectively illustrate the processes run by the controller 7 shown in FIG. 2 and the steps performed in the call admission control process. In this example, the control admission control system is implemented by an algorithm run by the controller 7 of the node n5 that seeks admission to the network.

Referring to FIG. 3, the controller 7 runs a main control process 8, which controls implementation of a number of ancillary processes for use in the control admission routine. The ancillary processes include a receiver node monitoring process 9 that is responsive to data from the receiver 5 to develop location data corresponding to the locations of active receiver nodes. A receiver location data simulation process 10 simulates data corresponding to the locations of the receiver nodes using the location data and some assumptions discussed in more detail hereinafter. A link gain matrix 11 process constructs the QCPC simulation link gain matrix A of equation (4.2) using data from the processes 9, 10. A SIR process 12 computes the maximum achievable value of the SIR from the matrix developed by matrix process 11. The main process 8 compares the SIR values with a reference value to judge whether admittance of the node is feasible.

The admission procedure is illustrated in FIG. 4 and starts at step S.01. A SINR threshold γ^{∞}, is defined for a new link M wishing to access the network (link m3 in this example).

At step S.01, the node n5 ascertains how many pairs of nodes are in operation within the network 1. To this end, the controller 7 of FIG. 2 drives the beam forming circuitry 4 to locate the direction and gain Gᵣ_{_{M}}ₛ_{ⱼ} of transmissions coming from individual, active nodes n in the network. The resulting data is collected by the receiver 5 and fed to the controller 7. The locations of the M−1 transmitter nodes for the network are then calculated from this data by the controller 7.

At step S.03, the count parameter k is initialised.

Then, at step S.04 the positions of the M−1 receiver nodes are simulated. This is carried out by simulating the possible positions of the receiver nodes, using the random distribution assumption discussed above, namely that each receiver node is situated at a location within a sphere around its respective sender node having a common radius Rₒ. As explained below, this initial random distribution is tested for accuracy, and if necessary, is updated in successive attempts until a sufficiently accurate simulation is achieved.

At step S.05 a QCPC simulation link gain matrix A of dimension M×M is constructed using the data corresponding to the positions of the transmitter nodes and the simulated positions for the receiver nodes of the M−1 links, and also the location of the nodes for link M. The matrix A is constructed according to equation (4.1).

Then at step S.06, in order to reduce the error rate, and having the knowledge of the actual positions of the M−1 sender nodes, the controller 7 of the incoming node calculates the maximum achievable SIR value, ŷ_{M-1}^{(k)} of the existing feasible network of M−1 links using a reduced A matrix having dimension (M−1)×(M−1). This is carried out using the approach of Grandhi et al. (1993) supra.

It is assumed that the existing network 1 of M−1 links is in operation and hence feasible with a SIR threshold γ^{∞}. If the value of the computed maximum achievable SIR value \hat{γ}_{M-1}^{(k)}=γ^{∞}, then the simulated receiver-to-sender positions for the existing feasible system involving M−1 pairs of nodes is not accurate enough because the simulation indicates the network is not feasible, which is not actually the case. The accuracy of the simulation is tested at step S.07 by determining if \hat{γ}_{M-1}^{(k)}<γ^{∞} in which case the process returns to step S.04. Then an updated set of receiver node locations are postulated using the aforementioned isotropic radial model and the process steps S.04-S.06 are repeated. This process repeats itself until a sufficiently accurate simulation of the node positions is obtained, as tested at step S.07.

When the simulation is sufficiently accurate, the maximum achievable SIR value \hat{γ}_{M}^{(k)} of the expanded network of M links is computed at step S.08 using the M×M matrix A, by following the previously discussed approach of Grandhi et al. (1993) supra.

The parameter k is incremented at step S.08 and process is repeated N times until it is determined at step S.09 that k=N, where N is the total number of simulated trials.

This generates a sequence Γ of predicted common SIR values involving M pairs of communicating nodes. A frequency analysis of these predicted values is then compared with a predetermined threshold value αε(0, 1) that corresponds to an acceptable probability measure for the new link M to join the network. In more detail:

Γ={\hat{γ}_{M}⁽¹⁾, \hat{γ}_{M}⁽²⁾, . . . , \hat{γ}_{M}^{(N)}}

and by denoting γ^{∞} as the required threshold such that the new link has to attain in order to be admitted into an existing feasible system, it follows that if:

P(Γ≧γ^{∞})≧α (4.2)

where

$$P ( Γ \geq {γ}^{∞} ) = \frac{{\sum }_{k = 1}^{N} {1}_{\{ {\hat{γ}}_{M}^{( k )} \geq {γ}^{∞} \}}}{N}$$

such that

$${1}_{\{ {\hat{γ}}_{M}^{( k )} \geq {γ}^{∞} \}} = \{ \begin{matrix}1 & if {\hat{γ}}_{M}^{( k )} \geq {γ}^{∞} \\ 0 & if {\hat{γ}}_{M}^{( k )} < {γ}^{∞}\end{matrix}$$

then the new link is then allowed to be admitted to the system. This relationship is tested at step S.10. If true, the controller 7 instructs the transmitter 6 to open the link at step S.11, such that the transmitter 6 starts transmitting on link m3 from node n5 in this example. If the relationship (4.2) is not true the new link is immediately rejected in step S.11.

If the node n5 is admitted to the network 1, the power control algorithms run by the controllers 7 of all the nodes n the support all the M links of the expanded network, adjust the power distribution between the links so that data can be transmitted over the newly admitted link m3.

Thus from the foregoing, it will be understood that the incoming node does not have any global information concerning all other link gains in the already feasible network. Instead, based on some mild assumptions on the relative location of the senders to the receiver nodes, it predicts the actual maximum achievable SIR of the network should it be admitted. In order to achieve a high probability of making accurate prediction (or low decision making error) in relation to the true SIR, a series of simulation studies is first performed to deduce the positions of other existing receiver nodes with respect to their sender nodes positions. Based on such information, for each topological scenario, it then constructs a quasi-centralized power control (QCPC) scheme and then calculates the maximum achievable SIR value. Using the SIR predictor scheme and based on some probability measures on the threshold requirements, the new node can then make an instantaneous decision on whether it should be admitted to the network. With the implementation of this scheme, the new call will cause less disturbance to existing calls as it tries to predict the maximum achievable SIR value that will be shared by all the links in the enlarged system (new and existing links). Furthermore the scheme is flexible enough to take into account how the power level updates for all existing links can be achieved, should the new call be allowed.

It is noted herein that while the above describes examples of the invention, there are several variations and modifications which may be made to the described examples without departing from the scope of the present invention as defined in the appended claims. One skilled in the art will recognise modifications to the described examples.

1. A method of controlling admission of a incoming node to a network in′ which communication takes place between nodes of the network over wireless links, the method comprising:
monitoring transmissions of transmitter nodes in the network to provide location data corresponding to their respective locations;
providing simulated location data corresponding to the locations of receiver nodes in the network that receive the transmissions over the links from respective ones of the transmitter nodes, based on the location data for the transmitter nodes;
computing a parameter corresponding to the maximum achievable value of a signal to interference relationship for transmissions over the links in the network when including the incoming node, as a function of the location data for the transmitter nodes and the simulated data for the receiver nodes; and
admitting the incoming node in dependence upon the value of said parameter.

2. A method according to claim 1 performed at the incoming node.

3. A method according to claim 1 including testing the accuracy of the simulated location data for the receiver nodes before computing the value of said parameter corresponding to said maximum achievable value of the signal to interference relationship.

4. A method according to claim 3 wherein said testing includes computing a test maximum achievable value of the signal to interference relationship for transmissions over the links in the network without the incoming node, as a function of the location data for die transmitter nodes and the simulated location data for the receiver nodes, and determining if the computed test maximum achievable value of the relationship is of a value that corresponds to a feasible network.

5. A method according to claim 4 including providing re-simulated location data corresponding to the locations of receiver nodes in the event that said test maximum achievable value of the signal to interference relationship does not correspond to a feasible network

6. A method according to claim 1 wherein the simulated location data is provided by postulating the location of a receiver node corresponding to each of the monitored transmitter nodes, at an essentially random location within a predetermined area surrounding the respective transmitter node.

7. A method according to claim 4 wherein said predetermined area corresponds to a circular area centred on the respective transmitter node.

8. A method according to claim 1 including admitting the incoming node if the computed maximum achievable value of the signal to interference relationship for transmissions over the links in the network when including the incoming node, adopts a predetermined relationship to a predetermined admittance value.

9. A method according to claim 8 including computing the maximum achievable value of the signal to interference relationship for transmissions over the links in the network when including the incoming node, a plurality of times to provide a plurality of computed values thereof, forming a average of said computed values, and comparing said average with a said admittance value.

10. A method according to claim 1 wherein said computing of said parameter includes constructing a link gain matrix for nodes in the network with link gains computed as a function of the distance between the transmitter a receiver nodes for the respective links of die network, utilising said transmitter location data and the simulated location data for the receiver nodes.

11. A method according to claim 10 including deriving the value of said parameter corresponding to the maximum achievable value of a signal to interference relationship for transmissions over the links, from the link gain matrix.

12. A wireless node configured to perform a method as claimed in claim 1.

13. A controller for a wireless node configured to perform a method as claimed in claim 1.

14. A wireless node with call admission control for controlling its admission as an incoming node to a network in which communication takes place between nodes over wireless links, the wireless node including: monitoring means configured to monitor transmissions of transmitter nodes in the network to provide location data corresponding to their respective locations; receiver location simulation means to provide simulated location data corresponding to the locations of receiver nodes in the network that receive the transmissions over the links from respective ones of the transmitter nodes, based on the location data for the transmitter nodes; processor means to compute a parameter corresponding to the maximum achievable value of a signal to interference relationship for transmissions over the links in the network when including the incoming node, as a function of the location data for the transmitter nodes and the simulated data for the receiver nodes; and admittance means to admit the incoming node in dependence upon the value of said parameter.

15. A node according to claim 14 including testing means operable to test the accuracy of the simulated location data for the receiver nodes before computing
said parameter corresponding to the maximum achievable value of the signal to interference relationship.

16. A node according to claim 15 wherein said testing means is operable to compute a test maximum achievable value of the signal to interference relationship for transmissions over the links in the network without the incoming node, as a function of the location data for the transmitter nodes and the simulated location data for the receiver nodes, and to determine if the computed test maximum achievable value of the relationship is of a value that corresponds to a feasible network.

17. A node according to claim 16 wherein the receiver location simulation means is configured to provide re-simulated location data corresponding to the locations of receiver nodes in the event that said test maximum achievable value of the signal to interference relationship does not correspond to a feasible network

18. A node according to claim 14 wherein the receiver location simulation means is configured to simulate the location of a receiver node corresponding to each of the monitored transmitter nodes, at an essentially random location within a predetermined area surrounding the respective transmitter node.

19. A node according to claim 18 wherein said predetermined area corresponds to a circular area centred on the respective transmitter node.

20. A node according to claim 14 wherein the admittance means is configured to admit the incoming node if the computed maximum achievable value of the signal to interference relationship for transmissions over the links in the network when including the incoming node, adopts a predetermined relationship to a predetermined admittance value.

21. A node according to claim 20 wherein the processor means is operable to compute the maximum achievable value of the signal to interference relationship for transmissions over the links in the network when including the incoming node, a plurality of times to provide a plurality of computed values thereof, and to form a average of said computed values, and the admittance means is operable to compare said average with a said admittance value.

22. A node according to claim 14 including an antenna, beam forming circuitry for controlling the directive pattern of the antenna, a transmitter and a receiver coupled to the antenna, and a controller coupled to the antenna beam forming circuitry, the transmitter and the receiver.

23. A node according to claim 14 wherein said processor means is configured to compute said parameter by: constructing a link gain matrix for nodes in the network with link gains computed as a function of the distance between the transmitter a receiver nodes for the respective links of the network, utilising said transmitter location data and the simulated location data for the receiver nodes, and deriving the value of said parameter from the link gain matrix.

24. A computer program to be run by a data processor in a wireless node to provide call admission control, operable to perform a method as claimed claim 1.

25. A computer program product to run by a processor of a wireless node for controlling its admission as an incoming node to a network in which communication takes place between nodes over wireless links, die program being configured to: monitor transmissions of transmitter nodes in the network to provide location data corresponding to their respective locations; to provide simulated location data corresponding to the locations of receiver nodes in the network that receive the transmissions over the links from
respective ones of the transmitter nodes, based on the location data for the transmitter nodes; compute the maximum achievable value of a signal to interference relationship for transmissions over the links in the network when including the incoming node, as a function of the location data for the transmitter nodes and the simulated data for the receiver nodes; and signal admittance of the incoming node to the network in dependence upon the computed maximum achievable value of the signal to interference relationship.
